(19) United States
(12) Patent Application Publication
(10) Pub. No.: US 2011/0063089 A1
(43) Pub. Date: Mar. 17, 2011

(54) RADIO FREQUENCY IDENTIFICATION (RFID) SYSTEM

(75) Inventor: Hee Bok KANG, Cheongju (KR)

(73) Assignee: Hynix Semiconductor Inc., Icheon (KR)

(21) Appl. No.: 12/755,247

(22) Filed: Apr. 6, 2010

(30) Foreign Application Priority Data
Sep. 11, 2009 (KR) 10-2009-0086022
Nov. 25, 2009 (KR) 10-2009-0114415

(51) Int. Cl. H04Q 5/22

(52) U.S. Cl. 340/10.34; 340/10.51

(57) ABSTRACT

A radio frequency identification (RFID) system is disclosed. The RFID system connects a sense-signal generator to a power-supply voltage VDD input terminal of an RFID chip so that it detects a power-supply operation status of the RFID chip using sensory organs of a human being. The RFID system includes an RFID chip configured to perform a data read/write operation upon receiving a radio frequency (RF) signal from an antenna, and a sense-signal generator configured to output an operation status of the RFID chip by connecting to the RFID chip.

### CROSS-REFERENCE TO RELATED APPLICATION

The priority of Korean patent application No. 10-2009-0086022 filed on Sep. 11, 2009, and 10-2009-0114415 filed on Nov. 25, 2009, the disclosure of which is hereby incorporated in its entirety by reference, is claimed.

### BACKGROUND OF THE INVENTION

Embodiments of the present invention relate to a Radio Frequency Identification (RFID) system, and more specifically, to a technology for automatically identifying an object by communicating with an external reader through transmission and reception of a radio frequency (RF) signal.

A Radio Frequency Identification (RFID) tag chip has been widely used to automatically identify objects using a radio frequency (RF) signal. In order to automatically identify an object using the RFID tag chip, an RFID tag is first attached to the object to be identified, and an RFID reader wirelessly communicates with the RFID tag of the object in such a manner that a non-contact automatic identification scheme can be implemented. With the widespread use of such RFID technologies, the shortcomings of related automatic identification technologies, such as barcode and optical character recognition technologies, can be greatly reduced.

In recent times, the RFID tag has been widely used in physical distribution management systems, user authentication systems, electronic money (e-money), transportation systems, and the like.

For example, a physical distribution management system generally performs a classification of goods or management of goods in stock using an Integrated Circuit (IC) recording data therein, instead of using a delivery note or tag. In addition, the user authentication system generally performs an Entrance and Exit Management function using an IC card including personal information or the like.

In the meantime, a non-volatile ferroelectric memory may be used as a memory in an RFID tag. Generally, a non-volatile ferroelectric memory [e.g., a ferroelectric Random Access Memory (FeRAM)] has a data processing speed similar to that of a Dynamic Random Access Memory (DRAM). The non-volatile ferroelectric memory also preserves data even when power is turned off. Because of these properties many developers are conducting intensive research into FeRAM as a next generation memory device.

The above-mentioned FeRAM has a very similar structure to that of DRAM, and uses a ferroelectric capacitor as a memory device. The ferroelectric substance has high residual polarization characteristics, such that data is not deleted although an electric field is removed.

FIG. 1 is a block diagram illustrating a general RFID device. The RFID device according to the related art generally includes an antenna unit 1, an analog unit 10, a digital unit 20, and a memory unit 30.

In this case, the antenna unit 1 receives a radio frequency (RF) signal from an external RFID reader. The RF signal from the antenna unit 1 is input to the analog unit 10 via antenna pads 11 and 12.

The analog unit 10 amplifies the input RF signal, such that it generates a power-supply voltage VDD indicating a driving voltage of an RFID tag. The analog unit 10 detects an operation command signal from the input RF signal, and outputs a command signal CMD to the digital unit 20. In addition, the analog unit 10 detects the output voltage VDD, such that it outputs not only a power-on reset signal POR controlling a reset operation but also a clock CLK to the digital unit 20.

The digital unit 20 receives the power-supply voltage VDD, the power-on reset signal POR, the clock CLK, and the command signal CMD from the analog unit 10, and outputs a response signal RP in response to the received signals to the analog unit 10. The digital unit 20 outputs an address ADD, Input/Output data (I/O), a control signal CTR, and a clock CLK to the memory unit 30.

The memory unit 30 reads and writes data using a memory device, and stores data therein.

In this case, the RFID device uses frequencies of various bands. In general, as the value of a frequency band is decreased, the RFID device has a slower recognition speed, has a shorter operating distance, and is less affected by peripheral environment (e.g., disruption from WiFi, cellphones, etc.) In contrast, as the value of a frequency band is increased, the RFID device has a faster recognition speed, has a greater operating distance, and is considerably affected by peripheral environment. It may also be difficult to tell when a connection is made with a RFID tag or the status of the communication. This is especially true when there are several RFID tags in close proximity.

### BRIEF SUMMARY OF THE INVENTION

Various embodiments of the present invention are directed to providing an RFID system that substantially obviates one or more problems due to limitations and disadvantages of the related art.

An embodiment of the present invention relates to an RFID system which connects a sense-signal generator to a power-supply voltage VDD input terminal of an RFID chip so that it can detect a power-supply operation status of the RFID chip using sensory organs of a human being.

An embodiment of the present invention relates to an RFID system which includes an electrostatic discharge (ESD) circuit in the RFID chip so that it can solve the ESD problem encountered in the sense-signal generator.

In accordance with one aspect of the present invention, a radio frequency identification (RFID) system includes an RFID chip configured to perform a data read/write operation upon receiving a radio frequency (RF) signal from an antenna, and a sense-signal generator configured to output an operation status of the RFID chip by connecting to the RFID chip.

As described above, the RFID system according to embodiments of the present invention connects a sense-signal generator to a power-supply voltage VDD input terminal of an RFID chip including an antenna so that it can detect a power-supply operation status of the RFID chip through sensory organs of a human being. Therefore, the RFID system checks an operation status of the RFID chip at any time, easily detects the presence or absence of access to the RFID chip in consideration of peripheral environments, and copes with the security problem of the RFID chip.

It is to be understood that both the foregoing general description and the following detailed description of the present invention are exemplary and explanatory and are intended to provide further explanation of the invention as claimed.

It will be appreciated by persons skilled in the art that that the effects that can be achieved with the present invention are not limited to what has been particularly described hereinabove and other advantages of the present invention will be more clearly understood from the following detailed description taken in conjunction with the accompanying drawings.

### BRIEF DESCRIPTION OF THE DRAWINGS

FIG. 1 is a block diagram illustrating an RFID device according to a related art.

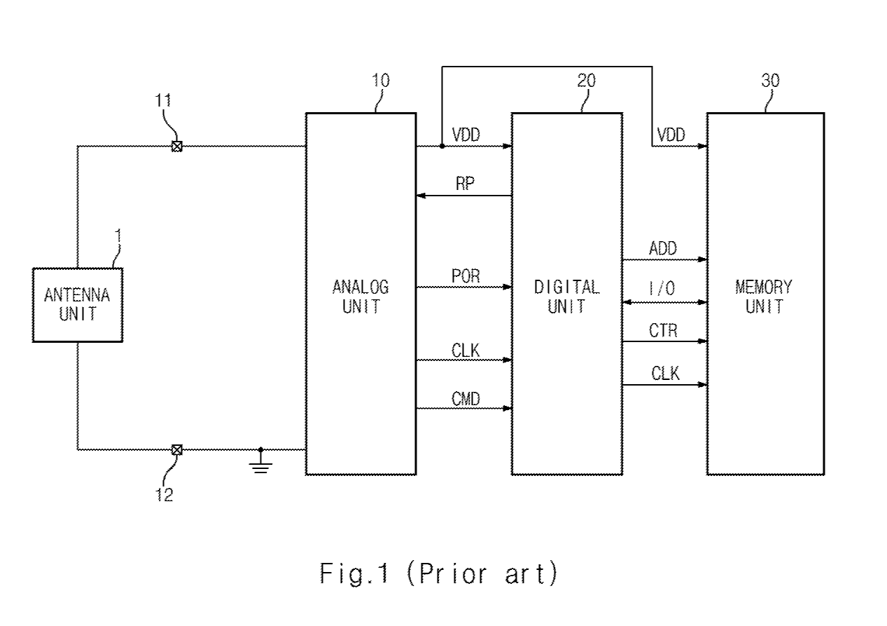

FIG. 2 is a block diagram illustrating an RFID system according to an embodiment of the present invention.

FIG. 3 is a detailed block diagram of the RFID system shown in FIG. 2 according to an embodiment of the present invention.

FIG. 4 is a timing diagram illustrating the RFID system shown in FIG. 3 according to an embodiment of the present invention.

FIG. 5 is a block diagram illustrating an RFID system according to another embodiment of the present invention.

FIG. 6 is a timing diagram illustrating an RFID system shown in FIG. 5 according to an embodiment of the present invention.

### DESCRIPTION OF EMBODIMENTS

Reference will now be made in detail to the embodiments of the present invention, examples of which are illustrated in the accompanying drawings. Wherever possible, the same reference numbers will be used throughout the drawings to refer to the same or like parts.

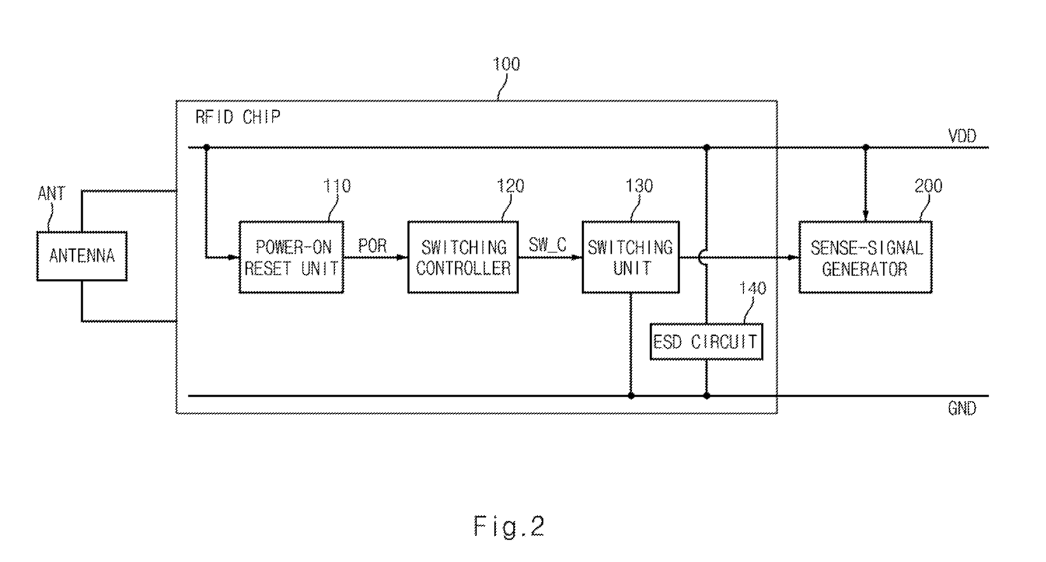

FIG. 2 is a block diagram illustrating an RFID system according to an embodiment of the present invention.

Referring to FIG. 2, the RFID system includes an antenna ANT, an RFID chip 100, and a sense-signal generator 200. In this case, the RFID chip 100 includes a power-ON reset unit 110, a switching controller 120, a switching unit 130, and an electrostatic discharge (ESD) circuit 140.

The antenna ANT receives an RF signal from an external RFID reader, and transmits the received RF signal to the RFID chip. The RF signal received via the antenna ANT is input to the RFID chip 100 through an antenna pad (not shown).

The power-ON reset unit 110 detects a power-supply voltage VDD and generates a power-ON reset signal POR to control a reset operation. The switching controller 120 outputs a switching control signal (SW_C) for a predetermined time when activated by the power-ON reset signal POR. The switching unit 130 activates the sense-signal generator 200 in response to the switching control signal (SW_C).

In addition, the sense-signal generator 200 is connected to a power-supply voltage VDD input terminal, and operates in response to the output signal of the switching unit 130. In this case, the sense-signal generator 200 generates a signal detectable by a human operator (e.g., light, sound, vibration, temperature, smell, humidity, etc.)

The ESD circuit 140 is contained in the RFID chip 100, and is connected between a power-supply voltage VDD input terminal and a ground voltage GND input terminal.

Therefore, the RFID system according to the embodiment of the present invention can discharge static electricity generated in the RFID chip 100.

In association with the RFID chip 100 including the antenna ANT according to the embodiment of the present invention, the sense-signal generator 200 is connected to both the power-supply voltage VDD input terminal of the RFID chip 100 and the ground voltage GND input terminal, so that a power-supply operation status of the RFID chip 100 is detected through the senses of the operator (e.g., sight, hearing, smell, etc.)

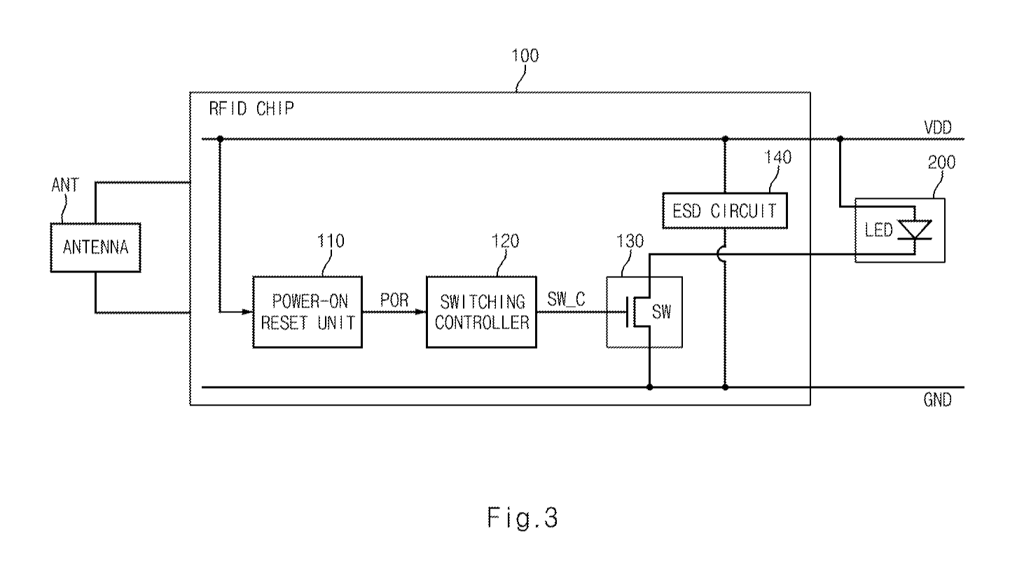

FIG. 3 is a detailed block diagram of the RFID system shown in FIG. 2 according to an embodiment of the present invention.

The switching unit 130 is connected between the sense-signal generator 200 and the ground voltage GND input terminal, and includes a switching element SW controlled by the switching control signal (SW_C). In this case, the switching element SW includes an N-type Metal Oxide Semiconductor (NMOS) transistor.

The sense-signal generator 200 may be formed of a Light Emitting Diode (LED). The LED element may be inversely connected between the power-supply voltage VDD input terminal and the switching unit 130.

The switching element SW of the switching unit 130 and the LED element of the sense-signal generator 200 are connected in series between the power-supply voltage VDD input terminal and the ground voltage GND input terminal.

According to the above-mentioned embodiment of the present invention, if the power-supply voltage VDD of the RFID chip 100 is increased, the power-ON reset unit 110 detects the increased VDD so that it outputs a power-ON reset signal POR. If the power-ON reset signal POR is activated (i.e., the signal goes from high to low), the switching unit 120 activates the switching control signal (SW_C). Therefore, the switching unit 130 is turned on, so that the sense-signal generator 200 connected between the power-supply voltage VDD input terminal and the ground voltage GND input terminal is operated.

Accordingly, according to the RFID system shown in the embodiment of the present invention, the LED element is illuminated when the RFID chip 100 is powered on, so that the power-supply operation status of the RFID chip 100 can be detected visually by an operator.

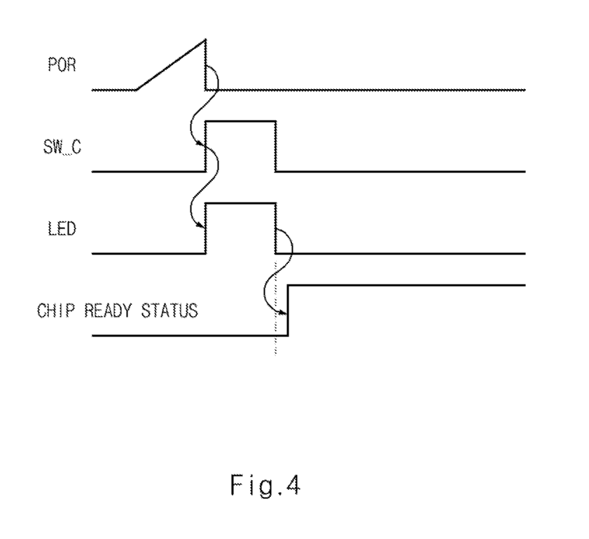

FIG. 4 is a timing diagram illustrating the RFID system shown in FIG. 3 according to an embodiment of the present invention.

Referring to FIG. 4, if a power-supply voltage VDD of the RFID chip 100 increases in level, the power-ON reset unit 110 detects the power-supply voltage VDD and outputs the power-ON reset signal POR. In other words, the power-ON reset signal POR gradually increases in proportion to the power-supply voltage VDD level, and if the VDD level reaches a predetermined voltage, the power-ON reset signal POR goes low in level.

Thereafter, the switching controller 120 detects the power-ON reset signal POR going low, so that it activates the switching control signal (SW_C) to be high in level and thus outputs the high-level activated switching control signal (SW_C). The switching controller 120 controls the switching control signal (SW_C) for a predetermined time using an internal delay element and thus outputs the switching control signal (SW_C) for a controlled time. As a result, the switching control signal (SW_C) maintains a high level status for the predetermined time caused by the delay element.

The switching element SW of the switching unit 130 is turned on when the switching control signal (SW_C) is activated. If the switching element SW is turned on, the sense-signal generator 200 connected between the power-supply voltage VDD input terminal and the ground voltage GND input terminal is operated so that the LED is illuminated.

In this case, the LED element maintains an activation status while the switching control signal (SW_C) is at a high level. If the switching control signal (SW_C) is set to a low level, the switching element SW is turned off. Therefore, connection between the LED element and the ground voltage GND input terminal is blocked so that the LED element is not operated.

Thereafter, when the LED element stops being operated on, the RFID chip 100 is ready to be driven. If both the RFID chip 100 and the LED element are driven at the same time the RFID system increases power consumption. Therefore, the LED element and the RFID chip 100 are not simultaneously operated.

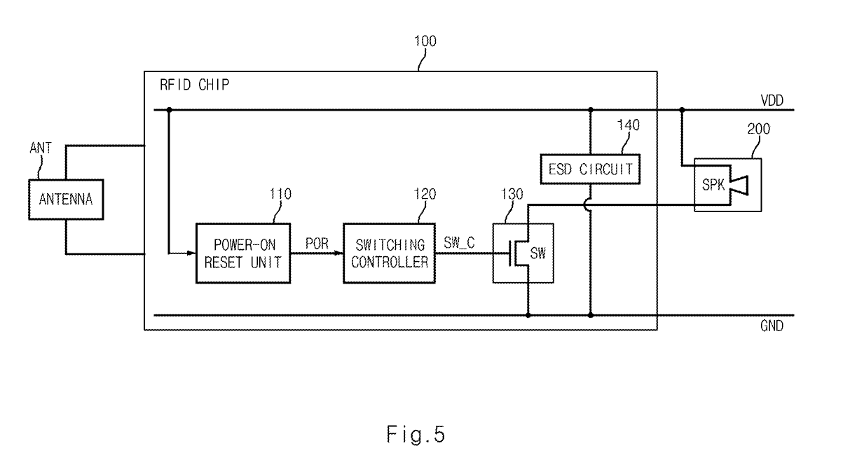

FIG. 5 is a block diagram illustrating an RFID system according to another embodiment of the present invention.

Referring to FIG. 5, the switching unit 130 is connected between the sense-signal generator 200 and the ground voltage GND input terminal, and includes a switching element SW controlled by the switching control signal (SW_C). In this case, the switching element SW includes an N-type Metal Oxide Semiconductor (NMOS) transistor.

The sense-signal generator 200 may be comprised of a sound driving device. For example, the sound driving device may be comprised of a speaker SPK. The speaker SPK is connected between the power-supply voltage VDD input terminal and the switching unit 130.

The switching element SW of the switching unit 130 and the speaker SPK of the sense-signal generator 200 are connected in series between the power-supply voltage VDD input terminal and the ground voltage GND input terminal.

According to the above-mentioned embodiment of the present invention, if the power-supply voltage VDD of the RFID chip 100 is increased, the power-ON reset unit 110 detects the increased VDD so that it outputs a power-ON reset signal POR. If the power-ON reset signal POR is activated (i.e., the signal goes from high to low), the switching unit 120 activates the switching control signal (SW_C). Therefore, the switching unit 130 is turned on, so that the sense-signal generator 200 connected between the power-supply voltage VDD input terminal and the ground voltage GND input terminal is operated.

Accordingly, according to the RFID system shown in the embodiment of the present invention, the speaker SPK outputs sound when the RFID chip 100 is powered on, so that the power-supply operation status of the RFID chip 100 can be heard (i.e., detected) by the operator.

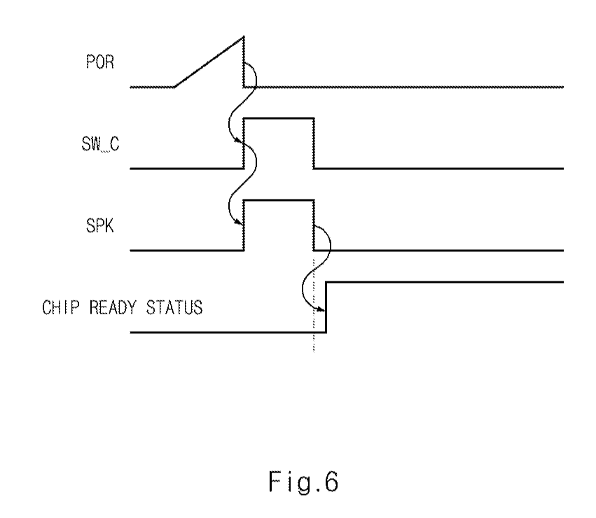

FIG. 6 is a timing diagram illustrating an RFID system shown in FIG. 5 according to an embodiment of the present invention.

Referring to FIG. 6, if a power-supply voltage VDD of the RFID chip 100 increases in level, the power-ON reset unit 110 detects the power-supply voltage VDD and outputs the power-ON reset signal POR. In other words, the power-ON reset signal POR gradually increases in proportion to the power-supply voltage VDD level, and if the VDD level reaches a predetermined voltage, the power-ON reset signal POR goes low in level.

Thereafter, the switching controller 120 detects the power-ON reset signal POR going low, so that it activates the switching control signal (SW_C) to be high in level and thus outputs the high-level activated switching control signal (SW_C). The switching controller 120 controls the switching control signal (SW_C) for a predetermined time using an internal delay element and thus outputs the switching control signal (SW_C) for a controlled time. As a result, the switching control signal (SW_C) maintains a high level status for the predetermined time caused by the delay element.

The switching element SW of the switching unit 130 is turned on when the switching control signal (SW_C) is activated. If the switching element SW is turned on, the sense-signal generator 200 connected between the power-supply voltage VDD input terminal and the ground voltage GND input terminal is operated so that the speaker PSK outputs sound.

In this case, the speaker SPK maintains an activation status while the switching control signal (SW_C) is at a high level. If the switching control signal (SW_C) is set to a low level, the switching element SW is turned off. Therefore, connection between the LED element and the ground voltage GND input terminal is blocked so that the speaker SPK is not operated.

Thereafter, when the speaker SPK stops being operated on, the RFID chip 100 is ready to be operated. If both the RFID chip 100 and the LED element are driven at the same time the RFID system increases power consumption. Therefore, the LED element and the RFID chip 100 are not simultaneously operated.

In recent times, an illumination lamp installed in a building or the like may generally include a plurality of LED elements. In this case, individual LED elements are turned on or off so that a special pattern of lights is formed. In addition, each illumination lamp may be controlled to have a user-desired brightness, or a certain illumination lamp arranged at a user-desired position may be separately controlled.

The above-mentioned scheme for controlling the illumination lamp may control the illumination lamp at a remote site through the RFID device. In other words, in the case where an RFID tag is attached to each LED and a desired radio frequency (RF) signal is transmitted to each RFID tag through an external reader, the RFID tag attached to the LED recognizes the transmitted RF signal and receives an additional comment according to a unique ID, so that the above-mentioned scheme can adjust as many LEDs as a user-desired number of LEDs and can control the user-desired number of LEDs to have a user-desired brightness.

If the RFID system according to the embodiment of the present invention is attached to the above-mentioned illumination lamp and the illumination lamp is turned on, the RFID chip 100 detects the turned-ON illumination lamp so that light or sound is output to an external part through the sense-signal generator 200.

In this case, the RFID system can easily recognize whether individual illumination lamps are correctly operated through the sense-signal generator 200. As a result, the RFID system can easily check the operation status of the RFID chip 100.

In addition, if an illumination lamp is turned on because an outsider approaches or enters a security area such as a computer installation area, the turned-ON illumination lamp can be notified to outside through the sense-signal generator 200. Therefore, if there arises a security problem undesired by the user, the RFID system enables a user to recognize the security problem according to the presence or absence of access to the RFID chip 100, resulting in the prevention of a dangerous situation.

As apparent from the above description, the RFID system according to embodiments of the present invention connects a sense-signal generator to a power-supply voltage VDD input terminal of an RFID chip including an antenna so that it can detect a power-supply operation status of the RFID chip through human senses (e.g., sight, hearing, etc.) Therefore, the RFID system checks an operation status of the RFID chip at any time and easily detects the presence or absence of access to the RFID chip in consideration of peripheral environments.

Although a number of illustrative embodiments consistent with the invention have been described, it should be understood that numerous other modifications and embodiments can be devised by those skilled in the art that will fall within the spirit and scope of the principles of this disclosure. Particularly, numerous variations and modifications are possible in the component parts and/or arrangements which are within the scope of the disclosure, the drawings and the accompanying claims. In addition to variations and modifications in the component parts and/or arrangements, alternative uses will also be apparent to those skilled in the art.

What is claimed is:

1. A radio frequency identification (RFID) system comprising:
an RFID chip configured to perform a data read/write operation upon receiving a radio frequency (RF) signal from an antenna, wherein the RFID chip is configured to be in one of a plurality of operation statuses; and
a sense-signal generator coupled to the RFID chip, the sense-signal generator configured to receive an operation status signal from the RFID chip and indicate an operation status of the RFID chip according to the operation status signal received.

2. The radio frequency identification (RFID) system according to claim 1, wherein the sense-signal generator is coupled to a power-supply voltage input terminal of the RFID chip.

3. The radio frequency identification (RFID) system according to claim 1, wherein the sense-signal generator includes a light emitting diode (LED) element.

4. The radio frequency identification (RFID) system according to claim 1, wherein the sense-signal generator includes a sound driving device.

5. The radio frequency identification (RFID) system according to claim 1, wherein the sense-signal generator generates any one of sense signals light, sound, vibration, temperature, smell, humidity, or a combination thereof.

6. The radio frequency identification (RFID) system according to claim 1, wherein operation status signal of the RFID chip indicates a status of a power-ON reset signal of the RFID chip.

7. The radio frequency identification (RFID) system according to claim 1, wherein the RFID chip includes:
a power-ON reset unit configured to generate a power-ON reset signal according to a power-supply voltage;
a switching controller coupled to the power-ON reset unit and configured to output a switching control signal by delaying the power-ON reset signal for a given time; and
a switching unit coupled to the switching controller and configured to drive the sense-signal generator according to the switching control signal,
wherein the switching unit is configured to provide the operation status signal to the sense-signal generator.

8. The radio frequency identification (RFID) system according to claim 7, wherein the switching unit is provided between the sense-signal generator and a ground voltage input terminal.

9. The radio frequency identification (RFID) system according to claim 8, wherein the switching unit includes an N-type Metal Oxide Semiconductor (NMOS) transistor.

10. The radio frequency identification (RFID) system according to claim 1, wherein the RFID chip enters a ready status when the sense-signal generator stops driving.

11. The radio frequency identification (RFID) system according to claim 1, wherein the RFID chip further includes an electrostatic discharge (ESD) circuit that is configured to receive the power supply voltage.

12. The radio frequency identification (RFID) system according to claim 11, wherein the ESD circuit is provided between a first node connected to a power-supply voltage input terminal of the RFID chip and a second node connected to a ground voltage input terminal.

13. The radio frequency identification system according to claim 12, wherein the sense-signal generator includes an input node coupled to the first node, and
wherein the power-ON reset unit is coupled to the first node to receive the power supply voltage.
